(19) United States
(12) Patent Application Publication
(10) Pub. No.: US 2018/0174055 A1
(43) Pub. Date: Jun. 21, 2018

(54) INTELLIGENT CONVERSATION SYSTEM

(71) Applicant: Giridhar S. TIRUMALE, Bangalore (IN)

(72) Inventors: Giridhar S. Tirumale, Bangalore (IN); Aravinda Ramagopal PALASAMUDRAM, Bangalore (IN)

(21) Appl. No.: 15/383,766

(22) Filed: Dec. 19, 2016

(51) Int. Cl. G06N 5/02; H04L 12/58; G06F 17/27; G10L 25/63; G06F 3/01

(52) U.S. Cl. CPC G06N 5/02; H04L 51/02; G06F 3/017; G10L 25/63; G06F 17/2785

(57) ABSTRACT

The present invention has given systems and methods for virtual recruitment of different candidates based on state model and, more specifically, candidate responses received during conversation session are recorded to create general pattern model that would be applied in the future session to give candidates a better personalized and immersive experience. The method comprises of providing a system-input to a user via at least one output unit of a system during a conversation session initiated by the user. The system-input being one of: information, question, and query. Receiving a user-input from the user in the conversation session from one or more one or more input devices coupled to the system. The input can be combination of audio, video, and text. After that, deduce the intent of the user-input. Then determining a response based at least in part on the query and the deduced intent and providing the response on the output unit within the conversation session.

### FIELD OF INVENTION

The present invention generally relates to intelligent systems. More particularly, the present invention relates to intelligent conversation system.

### BACKGROUND

Conversation has now taken a digital form. Apart from private conversations via chat applications, several users these days accesses information regarding product(s)/service(s) sold by the service provider via websites or specific client applications. The service provider can provide an online assistant that acts an interface between the user and information on the web site of the service provider. The assistant embodies a human representative of the service provider that is displayed on the website or specific client application. Example of such interface includes, but not limited to, online customer chat support. The online customer chat support interface enables the users to provide query such as complaint and request for further information regarding the product/service. In response, the service provider utilizes natural language processing techniques to identify contents of the user's query and provide a response to the user via the assistant.

Similar advancements have been made in various other sectors where an interaction or conversation with humans is required such as teaching and interviews. One such example of teaching is online teaching or tutoring. In such example, typically student and teacher can login to a secure web session and using a virtual whiteboard workspace write and share problems, solutions and explanations, and work with simulations and animations to maximize learning. An instant messaging or chat interface is also available for discussion. Likewise, examples of interviews include, but not limited to, interview simulations to prepare for actual interview and online platforms for conducting actual interviews. In these examples, pre-stored and pre-defined job related questions are asked to interviewee, and verbal and non-verbal response from the interviewee is recorded. A server evaluates the responses based on evaluation logic and predetermined rules, and provides report on multiple important parameters. Based on the report, further action is decided.

With the technology advances, however, user expectations increase. Being able to simply speak commands to a computing device was once impressive, today, this is commonplace and expected. Where users were once satisfied with one word commands or simple phrases, users are demanding better experiences with smarter devices that understand more.

Various solutions are available at present that provide better ways to facilitate user interaction or conversation. In one solution, as described in patent application US2013/0266925A1, methods and systems for interviewing human subjects are discussed. A virtual interface on a computing device asks questions to a user (i.e., human subject). The virtual interface is an intelligent agent having different genders with different demeanor. The user needs to answer all questions from a pre-stored script associated with the different intelligent agents. The computing device can receive a response from the user related to the question via one or more sensors associated with the computing device. The computing device can generate a classification of the response. The computing device can determine a next question based on a script tree and the classification. The computing device can direct the next question to the user using the intelligent agent. However, the conversation between the computing device and user is completely script directed. The termination will be done at the end of the script only whether the answers received by the user are relevant or not.

In another solution, as described in the patent application US2014/0074454A1, a conversation user interface enables patients to better understand their healthcare by integrating diagnosis, treatment, medication management, and payment, through a system that uses a virtual assistant to engage in conversation with the patient. The conversation user interface conveys a visual representation of a conversation between the virtual assistant and the patient. An identity of the patient, including preferences and medical records, is maintained throughout all interactions so that each aspect of this integrated system has access to the same information. The conversation user interface allows the patient to interact with the virtual assistant using natural language commands to receive information and complete task related to his or her healthcare. However, this implementation of the present solution is specific to providing medical assistance and therefore performs a single task. In other words, the solution is not scalable and expandable to other sectors. Further, the virtual assistant has pre-stored script of questions and answers. Therefore, the patient will not be provided with the exact solutions always. Such a conversation is more likely, one sided conversation, where patients has query to ask and system is available with pre-stored rules and response database.

In one another solution, as described in patent application U.S. Pat. No. 9,223,537B2, a conversation user interface enables users to better understand their interactions with computing devices, particularly when speech input is involved. The conversation user interface conveys a visual representation of a conversation between the computing device, or virtual assistant thereon, and a user. The conversation user interface presents a series of dialog representations that show input from a user (verbal or otherwise) and responses from the device or virtual assistant. Associated with one or more of the dialog representations are one or more graphical elements to convey assumptions made to interpret the user input and derive an associated response. The conversation user interface enables the user to see the assumptions upon which the response was based, and to optionally change the assumption(s). Upon change of an assumption, the conversation GUI is refreshed to present a modified dialog representation of a new response derived from the altered set of assumptions. In this way, the user can intuitively understand why the computing device responded as it did. For instance, by revealing the assumptions, the user can quickly learn whether the device misunderstood the verbal input (i.e., potentially a speech recognition issue) or whether the device misinterpreted the verbal input (i.e., potentially a natural language process issue). However, user intent is not exactly deduced by the system. The user has to give input multiple times so as to meet the system interpretation.

In another solution, as described in patent application US20120016678, an intelligent automated assistant system engages with the user in an integrated, conversational manner using natural language dialog. The system can be implemented using any of a number of different platforms, such as the web, email, smartphone, and the like, or any combination thereof. The system is based on sets of interrelated domains and tasks stored in a database, and employs additional functionally powered by external services with which the system can interact. Accordingly, input from the user is received in natural language form. The received user input is then interpreted using natural language processing algorithms to derive a representation of user intent. Based on the derived representation of user intent, at least one domain, at least one task, and at least one parameter for the task are identified from the database. External services can be invoked to obtain information or perform the identified task. Based on information received from the external service, output is rendered to the user. For example, the system may provide a conversational user interface in which the user provides input as “I'd like a romantic place for Italian food near my office”. The system may provide a response as a summary of its findings such as “OK, I found these Italian restaurants which reviews say are romantic close to your work:” and a set of results, i.e., listing of all the Italian restaurants on the conversation user interface. When the user clicks on the first result in the list, the result automatically opens up to reveal more information about the restaurant such as address, geolocation, distance from user's current location, and reviews about the restaurant, that is gathered and combined by the system from a variety of external services. However, the conversation between the user and an automated system is not intelligent and is based only on the predefined set of data with the system.

Therefore, there is a need for a better solution to improve user experience.

### SUMMARY

In accordance with the purposes of the invention, the present invention as embodied and broadly described herein, provides an intelligent conversation system.

Accordingly, in one embodiment, a user-input is received in a conversation session from one or more input devices coupled to a user-device. The user-input can be audio, video, text, or any combination thereof.

In one aspect of the invention, a system-input is provided to the user, prior to receiving the user-input, via at least one output unit of the user-device during the conversation session ebbing initiated by the user. The system-input being one of: information, question, and query. The system-input is selected from a script pre-associated with the conversation session. The script includes a list of questions, corresponding answers, and actions. Further, the conversation session is pre-associated with a plurality of context factors and a profile of the user. Thereafter, intent of the user input is deduced. The intent is deduced based on a plurality of parameters identified from the user-input. The parameters include similarity of concept between the user-input and the system-input, sentiment of the user, emotion of the user, gesture of the user, tone of the user, body language of the user, expression of the user, code of conduct of the user, environmental factors, and a duration from said providing until receiving of the user-input from the user.

Thereafter, a response is determined based on the deduced intent, intent deduced from user-input corresponding to system-input within a plurality of pre-stored conversation sessions, and the script. Further, the conversation session follows a state machine model implementation and therefore a state-machine model is pre-associated with the conversation session. The determination of the response also comprises of determining current state in state machine model based on the system-input. The state-machine model is traversed based on the user-input, the deduced intent, and one or more pre-stored rules to determine next state as the response.

In one aspect of the invention, upon termination of the conversation session, a set of conversation sessions from amongst a plurality of pre-stored conversation sessions based on the plurality of context factors and the profile of the user is selected. Based at least in part on deduced intent of user-input in the set of conversation sessions and learned behavior of users in the set of conversation sessions, a repetitive pattern in the set of conversation sessions is identified and a pattern model, generic context factors, and a generic profile of user is determined. Upon detecting an initiation of a new conversation session for a second user, a determination is made whether a plurality of context factors and a profile of the second user match with the generic context factors and the generic profile. Upon positive determination, the pattern model is applied to the new conversation session. Further, upon termination of the conversation session with user, feedback report based on intent deduced from user-input received during the conversation session is generated for further analysis.

The advantages of the present invention include but not limited to providing an intelligent conversation system that emulates human conversation by deducing intent and following a state machine model. As such, a personalized response is provided to the user, thereby improving user-experience. The conversation is both ways and is not only dependent upon script, thereby further improving user experience. In addition, the intelligent conversation system provides option to discontinue or continue a conversation session from a particular point in the session based on the intent and state machine models. Furthermore, the invention enables complete evaluation of every aspect of human behavior during the conversation and details analysis of the conversation session itself based on several parameters, thereby providing a comprehensive evaluation. This further enables drilling down information to provide insight about user's behavior.

### BRIEF DESCRIPTION OF THE ACCOMPANYING DRAWINGS

To clarify advantages and aspects of the invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings, which are listed below for quick reference.

FIGS. 1(a), 1(b), 1(c), and 1(d) illustrate an exemplary method for conducting intelligent conversation, in accordance with an embodiment of the present invention.

FIG. 2 illustrates an example network environment for conducting intelligent conversation, in accordance with the embodiment of present invention.

FIGS. 3(a), 3(b) illustrate an exemplary system implementing the method for conducting intelligent conversation, in accordance with the embodiment of present invention.

FIGS. 4(a), 4(b), & 4(c) illustrate an example depicting intelligent conversation in accordance with an embodiment of present invention.

FIG. 5 illustrates a typical hardware configuration of exemplary system, which is representative of a hardware environment for practicing the present invention.

Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the invention. Furthermore, the one or more elements may have been represented in the drawings by conventional symbols, and the drawings may show only those specific details that are pertinent to understanding the embodiments of the invention so as not to obscure the drawings with details that will be readily apparent to those of ordinary skill in the art having benefit of the description herein.

### DETAILED DESCRIPTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

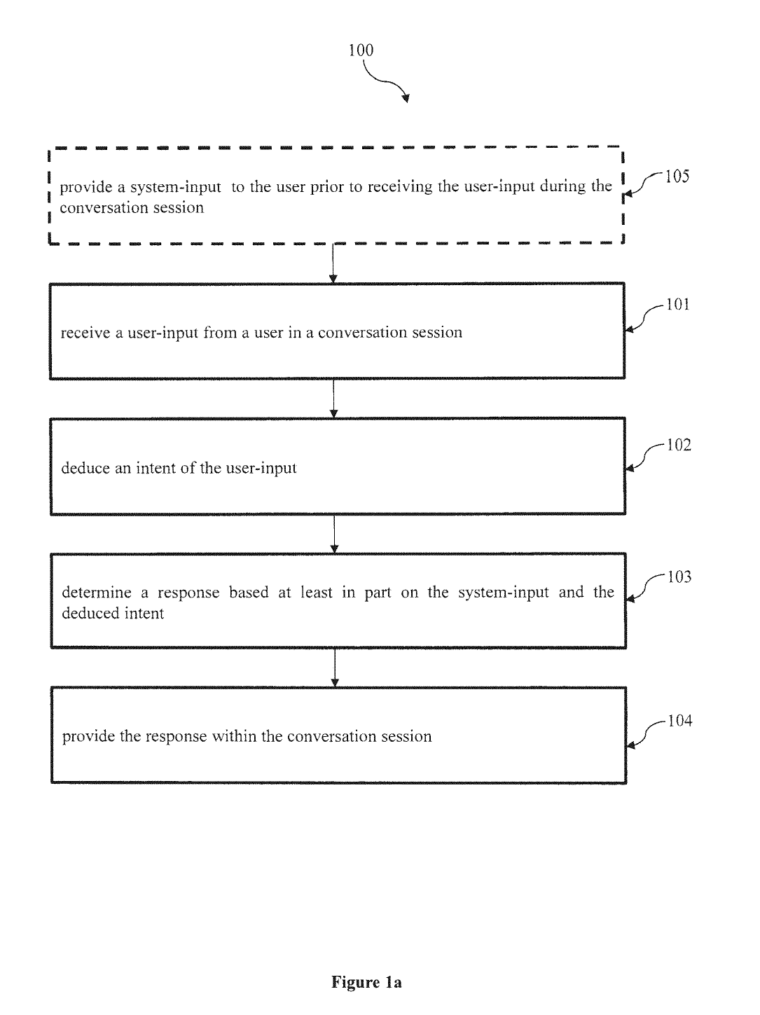

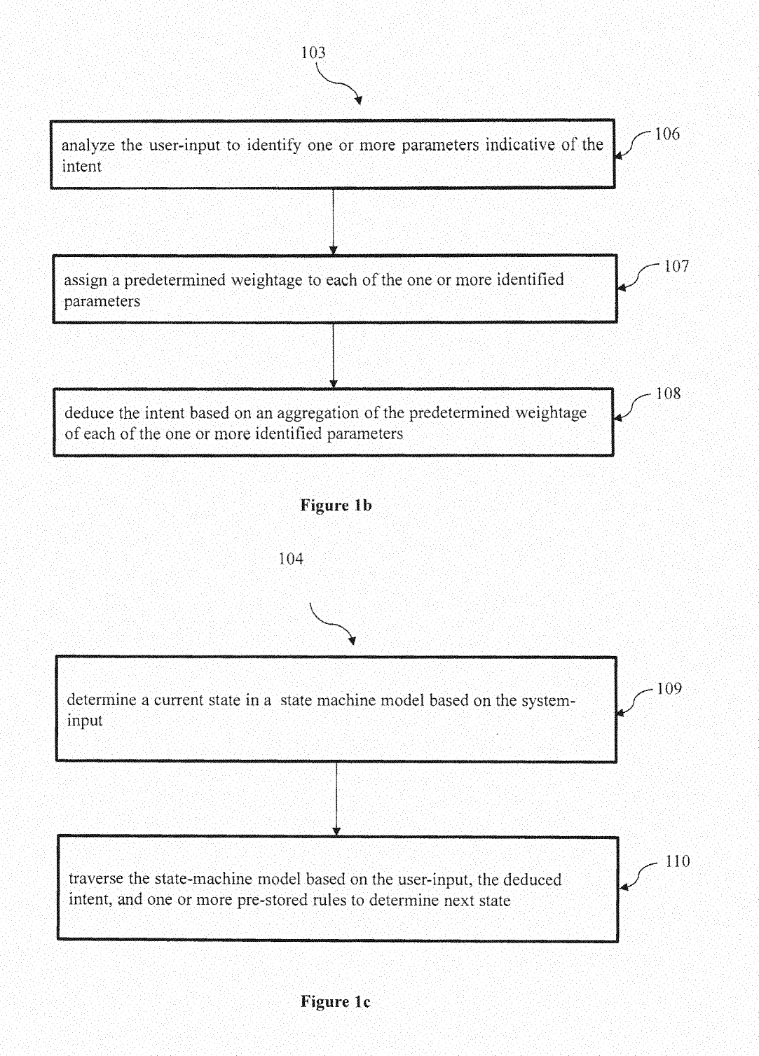

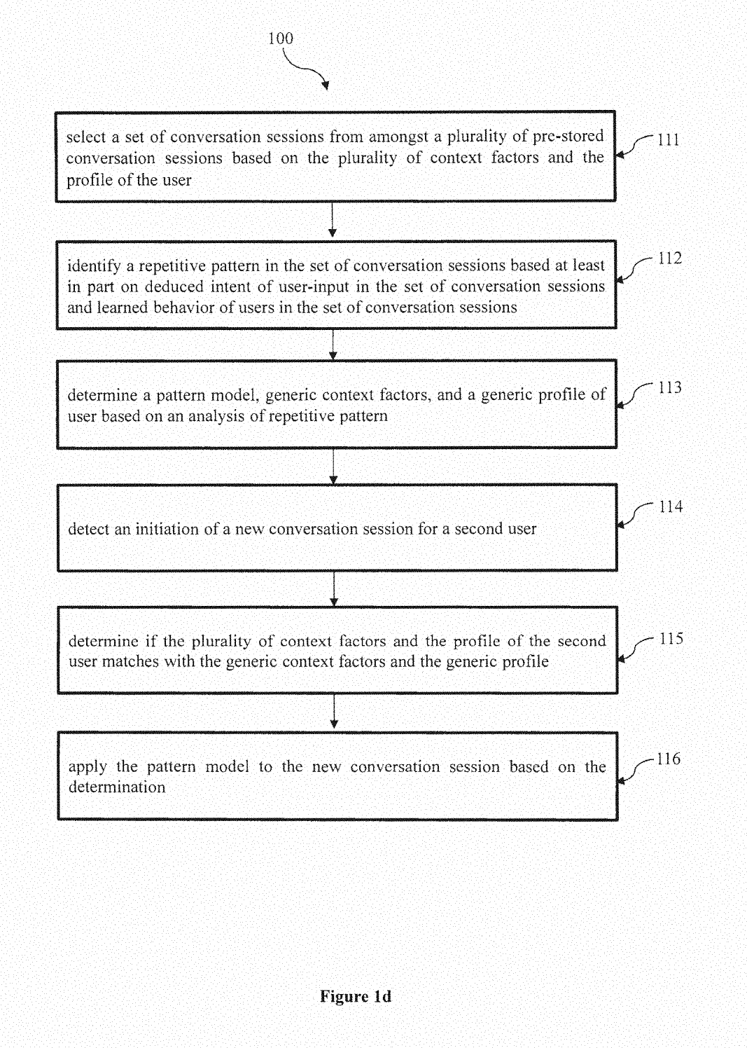

FIG. 1 illustrates an exemplary method 100 for conducting intelligent conversation in accordance with an embodiment of present invention. In said embodiment, referring to FIG. 1(a), at step 101 a user-input from a user is received in a conversation session from one or more input units coupled to a user-device. The user-input is a combination of audio, video, and text. The conversation session is initiated by the user.

At step 102, intent of the user-input is deduced.

At step 103, a response based at least in part on the system-input and the deduced intent.

At step 104, the response is provided on the output unit within the conversation session.

Further, in one aspect of the invention, an input can be provided to user prior to receiving the user-input. Accordingly, at step 105, a system-input is provided to the user via at least one output unit of the user-device in the conversation session. The system-input is provided prior to receiving the user-input. The system-input can be one of: information, question, and query. The system-input is selected from a script pre-associated with the conversation session, the script including a list of questions and mapped answers and actions.

Referring to FIG. 1(b), the step 103 of deducing intent of the user-input comprises further steps. Accordingly, at step 106, the user-input and the system-input is analyzed to identify one or more parameters indicative of the intent. The one or more parameters include similarity of concept between the user-input and the system-input, sentiment of the user, emotion of the user, gesture of the user, tone of the user, body language of the user, expression of the user, code of conduct of the user, environmental factors, and a duration from providing of the system-input to the user until receiving of the user-input from the user.

At step 107, a predetermined weightage is assigned to each of the one or more identified parameters.

At step 108, the intent is deduced based on an aggregation of the predetermined weightage of each of the one or more identified parameters.

Referring to FIG. 1(c), the step 104 of determination of response comprises further steps. Accordingly, at step 109, a current state in a state machine model is determined based on the system-input. The state-machine model is pre-associated with the conversation session.

At step 110, the state-machine model is then traversed based on the user-input, the deduced intent, and one or more pre-stored rules to determine next state. The next state comprises one of: a secondary question from the pre-stored script, the secondary question can be one of a follow-on question and different question; a repetition of the system-input; a resolution related to a user-query; a follow-up message; a termination message; and a repetition of the conversation session.

Further, the conversation session is pre-associated with a plurality of context factors and a profile of the user. Referring to FIG. 1(d), the method 100 comprises further steps upon the termination of conversation session. Accordingly, at step 111, a set of conversation sessions from amongst a plurality of pre-stored conversation sessions is selected based on the plurality of context factors and the profile of the user.

At step 112, a repetitive pattern in the set of conversation sessions is identified based at least in part on deduced intent of user-input in the set of conversation sessions and learned behavior of users in the set of conversation sessions.

At step 113, a pattern model, generic context factors, and a generic profile of user is determined based on an analysis of repetitive pattern.

This pattern model is then later applied to new conversation sessions. Accordingly, at step 114, an initiation of a new conversation session for a second user is detected. The new conversation session is also pre-associated with a plurality of context factors and a profile of the second user.

At step 115, a determination is made if the plurality of context factors and the profile of the second user match with the generic context factors and the generic profile.

At step 116, the pattern model is applied to the new conversation session based on the determination that the plurality of context factors and the profile of the second user matches with the generic context factors and the generic profile. As would be understood, if the plurality of context factors and the profile of the second user do not match with the generic context factors and the generic profile, the pattern model is not applied.

Further, the method 100 comprises the step of recording and storing a conversation session. Furthermore, the method 100 comprises the step of generating a feedback report upon termination of the conversation session. Such report is based on the intent deduced from user-input received during the conversation session. Thus, these stored conversation sessions and the feedback reports are used for further analysis as described above to give users a better personalised and immersive experience. In addition, the method 100 comprises the step of enabling a search for the stored conversation by a user.

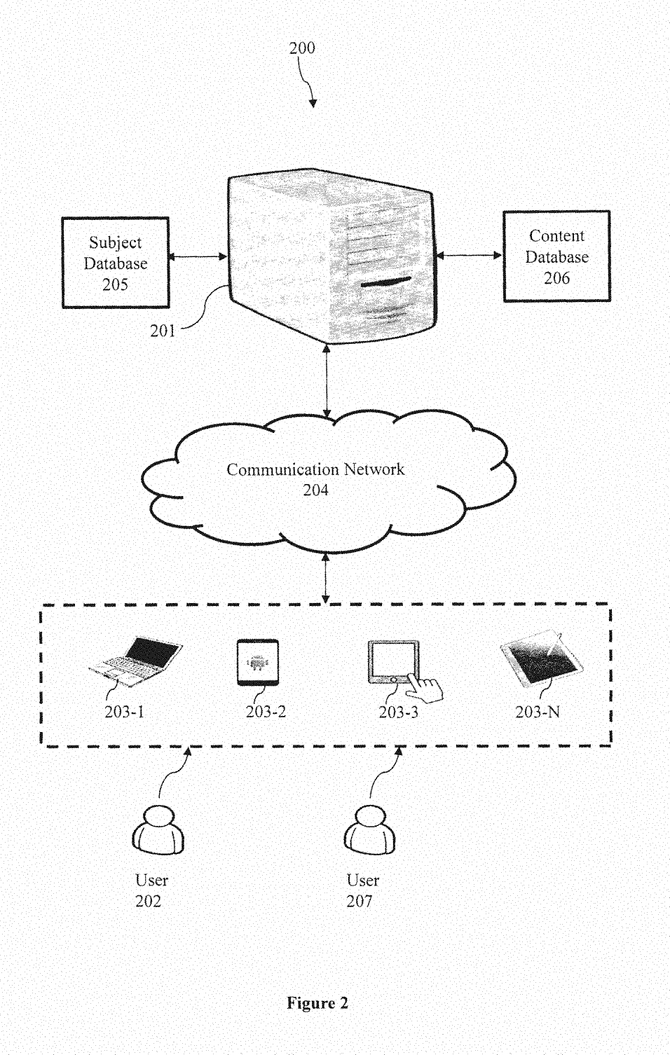

FIG. 2 illustrates an example network environment 200 for conducting intelligent conversation with humans, in accordance with an embodiment of the present invention. Examples of such conversation include, but not limited to, interview, technical support, and teaching. Accordingly, the network environment 200 includes an intelligent conversation system 201 implementing the method 100 for conducting intelligent conversation. The intelligent conversation system 201 can be accessed by a user 202 via one or more computing devices 203-1, 203-2, . . . 203-N, (hereinafter referred to as user-device 203 indicating one computing device and user-devices 203 indicating a plurality of computing devices) over a communication network 204. Examples of user-device 203 include, but not limited to, desktop, notebook, tablet, smart phone, and laptop. Thus, the intelligent conversation system 201 is implemented with multi-tenant architecture in client-server environment. In one implementation, the communication network 204 is cloud based network that further facilities ease of implementation.

The user-device 203 can be coupled with one or more input units (not shown in the figure) to receive various user-input in form of text, audio, video, and combination thereof. Examples of such one or more input units include, but not limited to, high-definition video camera, microphone, touch-based display unit, non-touch based display unit, sensor, wearable device, keyboard, stylus, and mouse. The sensors can be non-invasive and invasive. Examples of the sensor include, but not limited to, fingerprint sensor, eye tracking device, proximity sensor, vocal pitch sensor, thermal sensors, and infrared sensors. Examples of the wearable devices include, but not limited, to smart watch, smart glasses, GPS trackers, and headphone.

In accordance with the invention, the intelligent conversation system 201 facilitates user-interaction by engaging a user in an integrated, conversation manner and emulates a human conversation in various applications. Examples of the applications include, but not limited to, online interview (simulation or in-person), online customer chat support, online healthcare assistant, online immigration check, and online teaching or tutoring. The intelligent conversation system 201, therefore, implements a conversation session that engages a user in a conversation that emulates human conversation, as explained in below paragraphs.

Accordingly, the user 202 can access the intelligent conversation system 201 (hereinafter interchangeably referred to as system 201) via the user-device 203 to create plurality of context factors and a profile of a third party or user who will be engaging with the conversation session in various applications. Examples of the user 202 can include, but not limited to, interviewer, product manager, medical examiner, immigration officer, and teacher. The user 202 can be administrator or a person having suitable authority. The plurality of context factors and the profile of the third party can be associated with the conversation session. The plurality of context factors can include characteristics of the conversation session. The profile of the third party can include personal data associated with the third party. Examples of personal data include, but not limited to, name, age, experience, education, and contact information.

Further, the user 202 can create a script including a list of questions and mapped answers and associate the script with the conversation session. The script can be created manually using general or special purpose software applications such as integrated development environment (IDE) or automatically using special purpose software applications. Accordingly, the user 202 can fetch one or more questions and mapped answers from a subject database or storage unit (hereinafter referred interchangeably) 205 communicatively coupled with the system 201. The subject database 205 includes contains indexed questions, statements responsive to the questions, and semantic expansions of the questions and statements related to various fields. The subject database 205 can be periodically updated such that latest information is available for creating the script.

In one example, the subject database 205 can include indexed questions, statements responsive to the questions, and semantic expansions of the questions and statements related to product(s)/service(s) being offered by a company. In another example, the subject database 205 can include indexed questions, statements responsive to the questions, and semantic expansions of the questions and statements related to various technologies being used by employees in an organization for performing their operations. Thus, the script may not necessarily define an actual flow of questions and answers but rather an indication of next question that might follow based on an input from the user, as explained in later paragraphs.

The script can also include possible set of actions for the user-device 203 to take during the conversation session. The possible set of actions is mapped to the questions along with the answers. The possible set of actions can include, but not limited to, waiting for third party to provide an input (i.e. user-input), waiting for a completion of an action to process an interruption, handling exceptions related to network, and handling timeouts during wait. Examples of interruptions can include, but not limited to, user interruptions such as gesture for pausing and gesture for not able to hear properly, and technical interruptions such as network problem. The script can also include possible set of transitions upon receiving input from the third party via the user-device 203 and interruptions from the user-device 203.

In one example, the conversation session can be an online in-person interview related to a post of Java software developer. The subject database 205 can include indexed questions, statements responsive to the questions, and semantic expansions of the questions and statements related to various languages such as Java, Python, S Q L, and Pearl, and various posts such as software developer and database administrator. Accordingly, the user 202 can be an interviewer and the third party can be an interviewee. The interviewer can create a plurality of context factors and a profile of the interviewee (in accordance with post for which the interview is being interviewed. The plurality of context factors can include, but not limited to, position/post, length of the interview, status or stature of the interviewee or interviewer, relevance or value of information discussed in the interview, subject of the interview, date, and time. The profile of the interviewee can include, but not limited to, personal data, education history, career history, residence history, driving records, criminal records, background check information, and government agency disclosures. In addition, the interviewer can create a script list of questions and mapped answers for evaluating technical aspects, communication skills, interpersonal skills, personality, aptitude, and capabilities for fulfilling work-related responsibilities related to the post by fetching relevant questions, statements responsive to the questions from the subject database 205. The interviewee can also define mapped actions such as waiting for 10 seconds to receive an input from the interviewer and then repeating the question.

In another example, the conversation session can be an online technical support provided by a manufacturer for a product A. The subject database 205 can include indexed questions, statements or answers responsive to the questions, and semantic expansions of the questions and statements related to various products including product A. Accordingly, the user 202 can be an administrator and the third party can be a consumer of the product A. The administrator can create a plurality of context factors and a profile of the consumer in accordance with various technical queries that can often arise while using the product/service. The plurality of context factors can include type of product/service being offered, level of understanding of the consumer, etc. The profile of the consumer can include personal data associated with the consumer. In addition, the administrator can create a script list of questions and mapped answers for the technical queries related to the product A by fetching relevant questions, statements or answers responsive to the questions from the subject database 205. The administrator can also define mapped actions such as waiting for 10 seconds to receive an input from the user and then repeating the answer or ask a question.

Accordingly, the system 201 stores the plurality of context factors and the profile of the user along with the script as content in a content database or storage unit (hereinafter referred interchangeably) 206 communicatively coupled with the system 201. The content can be stored in content knowledge markup language (CKML) and artificial intelligence markup language (AIML) in the content database 206. In addition, the user 202 can store default preferences and exception preferences for the conversation session. The default preferences and exception preferences can be defines as rules that are applied to the possible set of actions and the possible set of interruptions that the user-device 203 takes during the conversation session. The default preferences can be global preferences, user specific preferences, and session specific preferences. Examples of the exception preferences include, but not limited to, no intent found and problem with received input. Thus, the content database 206 stores the script that is created using data pre-stored in the subject database 205. In the above example of online in-person interview, once the interviewer has created the script for the post of Java software developer, the system 201 stores the script in the content database 206. Similarly, in the above example of online technical support, once the interviewer has created the script for the product A, the system 201 stores the script in the content database 206.

In one implementation, the storage units 205, 206 can be internal to the system 201. In another implementation, the storage units 205, 206 can be external to the system 201. For the sake of brevity, only one storage unit is illustrated in the figure. It would be understood that the system 201 may be coupled with a plurality of storage units to store information, as described above.

Upon creation of the content, the intelligent conversation system 201 can create a link to enable the third party to initiate the conversation session on a user-device. The conversation session, as described earlier, can be conversation graphical user interface (GUI) that engages the third party in a conversation that emulates human conversation. In one implementation, the conversation GUI may include a virtual assistant such as avatars that has a human-like personality and persona. The conversation GUI can be in various forms such as chat session GUI. Upon accessing the link, the conversation session is opened on the user-device. In the above example of online interview session, the system 201 can create a uniform resource locator (URL) and send the URL via an email to the interviewee. The interviewee can access the URL to initiate the conversation session on the user-device 203. In the above example of online technical support, the system 201 can create a corresponding icon and provide the same via a web-browser. The user can access the icon to initiate the conversation session. The system 201 can implement the method 100 upon initiation of the conversation session as described below.

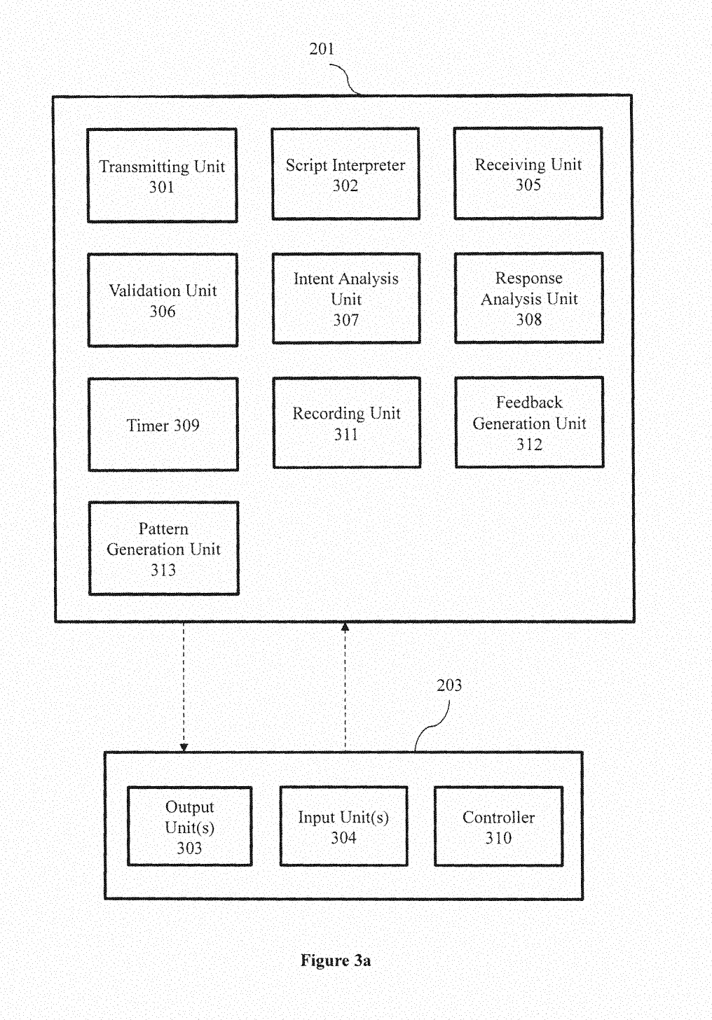

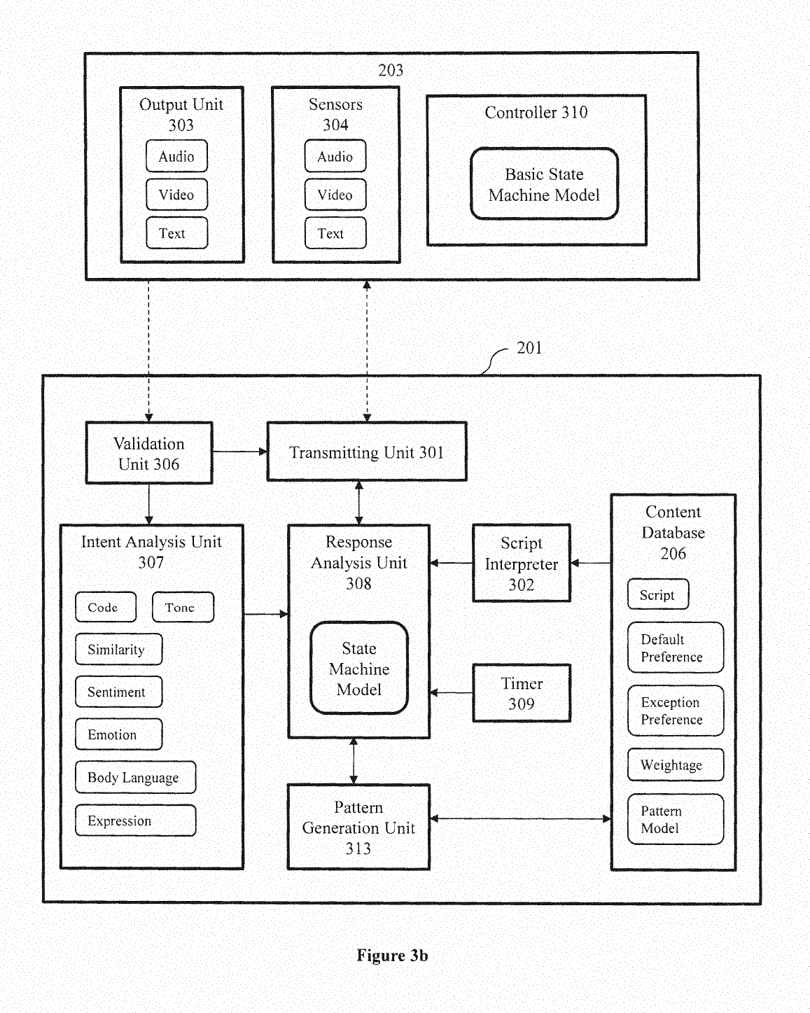

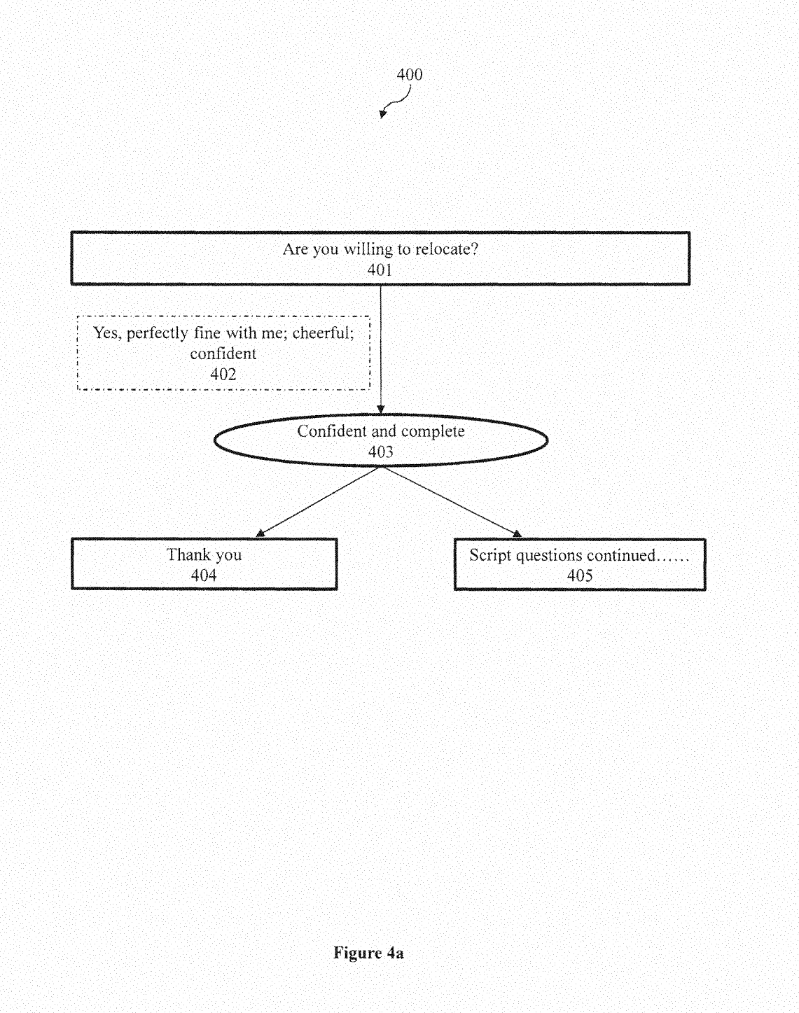

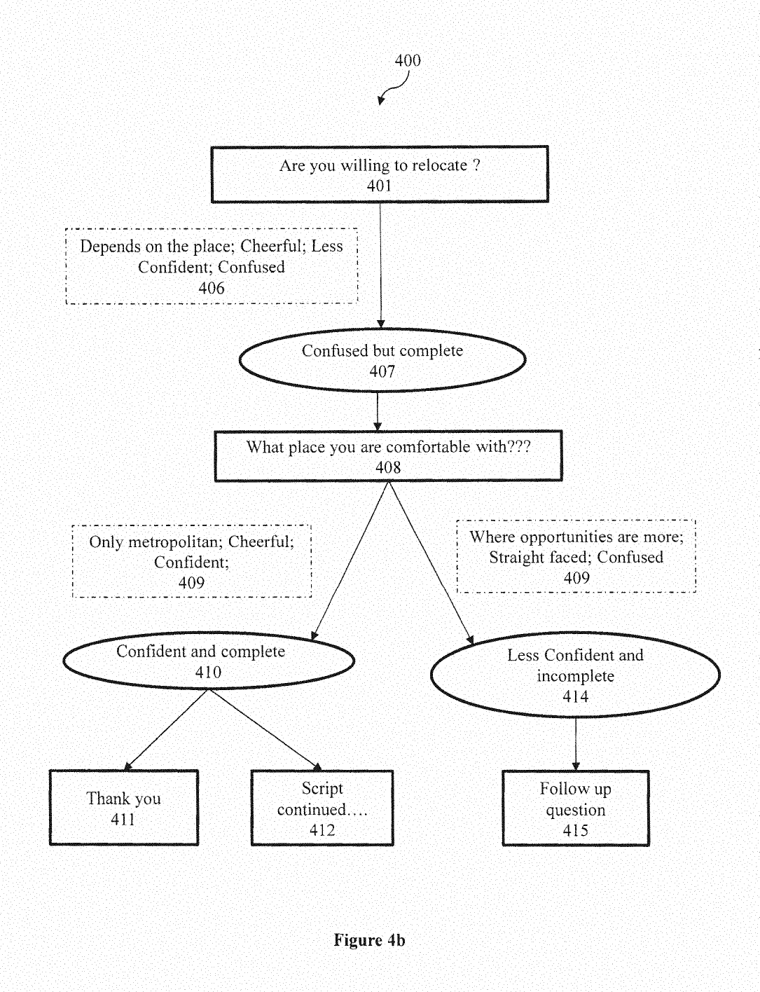

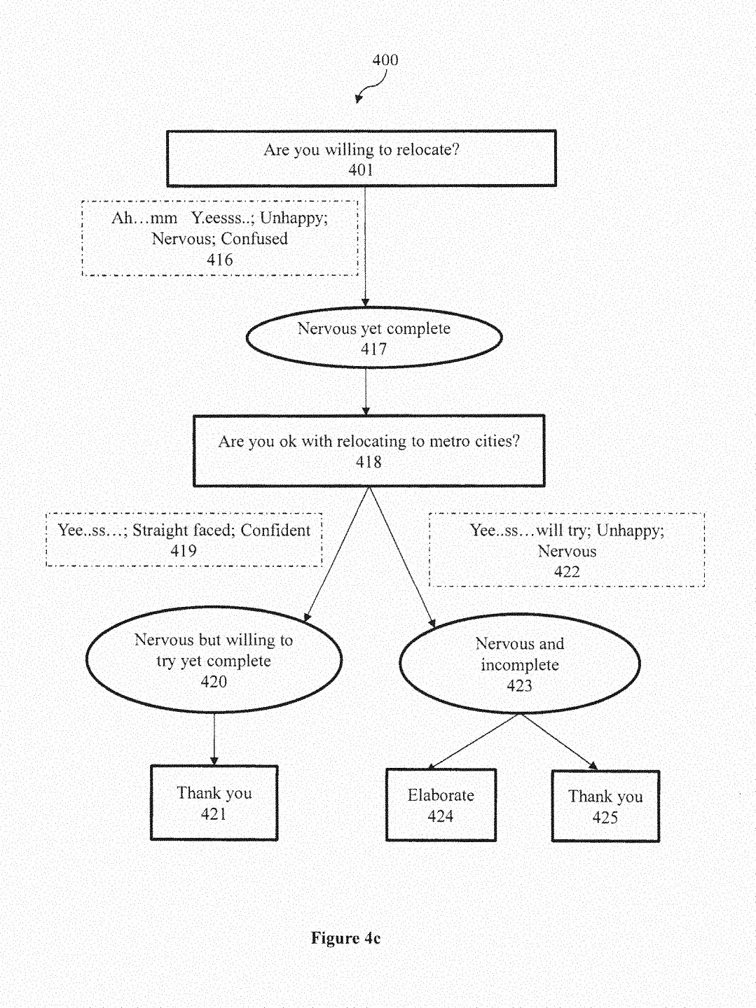

FIGS. 3 and 4 and corresponding description will now describe implementation of the invention upon accessing the link and initiating the conversation session. As would be understood, the network environment 200 as described with reference to FIG. 2 shall remain same. Therefore, in accordance with the invention, user 207 can access the link via the user-device 203 and initiate the conversation session. The user 207 or the third party (hereinafter referred interchangeably) who will be engaging with the conversation session in various applications. As mentioned earlier, examples of the applications include, but not limited to, online interview (simulation or in-person), online customer chat support, online healthcare assistant, online immigration check, and online teaching or tutoring. Accordingly, examples of the user 207 can include, but not limited to, interviewee, customer, patient, traveler, and student.

FIG. 3a illustrates a block diagram of the intelligent conversation system 201 and FIG. 3b illustrates a high level architecture of the intelligent conversation system 201 implementing the method 100 for conducting intelligent conversation, in accordance with the embodiment of the present invention.

Referring to FIGS. 2, and 3a 3b, the system 201 includes transmitting unit 301 to provide system-input to the user-device 203 during a conversation session initiated by the user 207. The conversation session can be initiated by the user 207 as described earlier.

The system-input can be information, question, and query and can be in form of audio, video, text, and combination thereof. The system-input is selected from the script pre-associated with the conversation session. Accordingly, the system 201 can fetch the script from the content database 206 and a script interpreter 302 parses the script and provides the system-input to the transmitting unit 301. The transmitting unit 301 provides the system-input at an output unit 303 of the user-device 203 via the communication network 204, represented by dashed arrows. The output unit 303 can include display unit for displaying video and text, and audio output unit such as speakers for providing audio. In an example, the video can be 3D animation or projections. In an example of online interview session, upon initiating the conversation GUI, the system 201 can select the script associated with the interview session from the content database 206 and provide a greeting message, as outlined in the script, as the system-input on the user-device 203. In such example, a 3D avatar can be presented on the output unit 303 that voices the questions from the script. Projections, graphs, or any other text can be also displayed on the output unit 303 based on the script.

Upon receiving the system-input, the third party or user 207 (hereinafter referred interchangeably) will provide a user-input. The user-input can be audio, video, text, and combination thereof. The user-input can also be indicative of physiological and behavioral cues/indicators of the human, i.e., the user 207. Physiological cues may be diagnostic of emotional state, arousal, and cognitive effort/reactions such as heart rate, blood pressure, respiration, pupil dilation, facial temperature, and blink patterns in response to questions/query. Behavioral cues include, but not limited to, kinesics, proxemics, chronemics, vocalics, linguistics, eye movements, body language, facial expression, and message content.

As such, the user-device 203 includes one or more input units 304 for receiving the user-input and transmitting to the system 201. Examples of the input unit 304 include, but not limited, to high-definition video camera, microphone, touch-based display unit, sensor, wearable device, keyboard, stylus, and mouse. The sensors can be non-invasive and invasive. Examples of the sensor include, but not limited to, fingerprint sensor, eye tracking device, proximity sensor, vocal pitch sensor, thermal sensors, and infrared sensors. Examples of the wearable devices include, but not limited, to smart watch, smart glasses, GPS trackers, and headphone.

The one or more input units 304 capture the user-input and send the user-input to the system 201 over the communication network 204, represented by dashed arrows. In the above example, to an interview question, the user-input can be an oral answer provide by the interviewee and a video capturing a body language, blink pattern, and a facial expression of the interviewee. For the sake of brevity, both the system input and user input are illustrated in single block in FIG. 3b. As would be understood, the input units 304 can capture the user-input and send or share the user-input with the system 201 in any format such as digital data, analog data, and combination thereof. In addition, in one implementation, the user-input can be directly sent to the system 201.

Further, it would be understood, that the system-input may or may not be a first message or input in the conversation session. In one aspect of the invention, the system-input is a first input or message in the conversation session associated with specific applications and is provided on the output unit 303, prior to receiving the user-input. Examples of such application can be, but not limited to, online interview session and online healthcare assistant. In such examples, upon initiating the conversation session, the first input can be a greeting message provided by the system 201 to the user such as “hello”, “hi, I am nurse abha, how can I help you?”, and “welcome to XYX tech support”.

In another aspect of the invention, the system-input is a second input in the conversation session after the user provides an initial message in the conversation session. In such aspect, the system-input can become the response provided by the system 201, as described in later paragraphs. Examples of such conversation session can be, but not limited to, online technical support and online teaching. In such examples, upon initiating the conversation session, the first input can be a greeting message provided by the user to the system 201 such as “hello”, “I want to know about product A” and “can you help me with subject B”.

Further, the system 201 includes a receiving unit 305 to receive the user-input from the one or more input units 304 over the communication network 204. The system 201 further includes a validation unit 306 to validate the user-input from the one or more input units 304. Examples of the validation include, but not limited to, video or audio or text is in accordance with allowed formats and audio is in accordance with threshold.

The system 201 further includes an intent analysis unit 307 to deduce intent of the user-input. The intent can be defined as information abstracted or generated from the user-input that provides insight into behavior of user 207 and enables emulating human conversation. For example, intent can be deduced as ‘thinking’ from gaze behavior and ‘stressed’ from vocal pitch. Upon receiving the user-input, which has been validated, the intent analysis unit 307 analyzes the user-input to identify one or more parameters indicative of the intent. The one or more parameters include similarity of concept between the user-input corresponding to the system input, sentiment of the user, emotion of the user, gesture of the user, tone of the user, body language of the user, expression of the user, code of conduct of the user, and environmental factors. The intent analysis unit 307 uses various techniques for analyzing the user-input such as speech synthesis, expression analysis, natural language processing, voice analysis, vision analysis, feature analysis, and latent semantic processing to identify the one or more parameters indicative of the intent.

In one example, the intent analysis unit 307 analyzes audio from the user-input converted to text or text from the user-input using latent semantic algorithm to extract required concept summary and compare similarity against the given concept from the script to get a percentage of similarity or dissimilarity. In another example, the intent analysis unit 307 analyzes text such as code from the user-input against expected code, standard, and output to determine similarity or dissimilarity of concept. In another example, the intent analysis unit 307 analyzes text and/or audio from the user-input to determine sentiment of the user. In another example, the intent analysis unit 307 analyzes text and/or audio and/or video from the user-input to determine emotion of the user. In another example, the intent analysis unit 307 analyzes video from the user-input to determine gesture, body language, and expression of the user in order to handle the interruptions appropriately. In another example, the intent analysis unit 307 analyzes audio from the user-input to determine jitters, pauses, pitch, and speed.

Upon identifying the one or more parameters, the intent analysis unit 307 assigns a predetermined weightage to each of the one or more identified parameters. Accordingly, the intent analysis unit 307 fetches a table indicative of mapping of predetermined weightage with the parameters from the content database 206. In one implementation, the table is created one time only and is generic to all conversation sessions. In another implementation, the table is created at time of creating the script and is specific to current conversation session. The intent analysis unit 307 then deduces the intent based on an aggregation of the predetermined weightage of each of the one or more identified parameters.

Furthermore, the system 201 includes a response analysis unit 308 to determine a response. After deducing the intent, the response analysis unit 308 determines the response based on the user-input, the intent deduced from user-input corresponding to the current system-input within the conversation session. The response can be follow-on question and different question from the script; a repetition of the system-input; a resolution related to a user-query; a follow-up message such as context for a question, advance information about the question, and elaboration on the nature of the question; a termination message; and a repetition of the conversation session. In addition, the response analysis unit 308 determines the response based on the intent deduced from user-input corresponding previous or prior system-input within the current conversation session, intent deduced from user-input corresponding previous or prior system-input within a plurality of pre-stored conversation sessions and the script.

To this end, the response analysis unit 308 implements a state machine model that includes well-defined finite states such as start, intermediate, and termination nodes or states. Each conversation session is associated with a state machine model by the response analysis unit 308. The response analysis unit 308 then determines a current state in the state machine model as either the system-input or the response and performs respective operations or actions associated with the current state. The response analysis unit 308 further transits to a next state as the response based on the user-input. For example, a start state or node can be an initial or first system-input and an intermediate state can be a second system-input. Thus, the start state can be the current state. Upon determining the current state, the response analysis unit 308 determines a next state or the response by traversing the state-machine model based on the user-input, the deduced intent, and one or more pre-stored rules. The one or more rules determine how the default preferences, the exception preferences, and time need to be applied to the state machine model. Examples of the rules include, but not limited to, system related rules such as interruptions and handling timeouts during wait, and user related rules such as waiting time for receiving the user-input. These rules are stored in the content database 206.

Further, the next state can be a secondary question such as follow-on question and different question from the script; a repetition of the system-input; a resolution related to a user-query; a follow-up message such as context for a question, advance information about the question, and elaboration on the nature of the question; a termination message; and a repetition of the conversation session. In addition, intermediate states can be process, communicate, and wait. The operations or actions associated with states can include, but not limited to, fetching and processing script from the content database 206, providing the response to the user 207, waiting for user-input, handling exceptions related to the network 204, handling timeouts during wait, waiting for next state from the user-device 203, waiting for the user-device 203 to process interruption, and communicating current state to the user-device 203.

Upon determining the next state, the response analysis unit 308 determines next action. Based on the next action, the response analysis unit 308 fetches the script from the content database 206 via the script interpreter 302 and provides the response to the transmitting unit 301. The transmitting unit 301 then provides the system-input at the output unit 303 of the user-device 203 via the network 204.

Thus, in above example, upon receiving the user-input, the response analysis unit 308 then determines the current state in the state machine model as the response and transits to a next state as response based on the user-input. It would be understood that the response can be provided as system-input to the user in the conversation session.

FIG. 4 illustrates an example implementing the state machine model 400 for interview process in accordance with the embodiment of present invention, as described above. For the sake of illustration, solid line rectangle indicate current and next states as system-input, dashed rectangle indicate the user-input, and oval shaped box indicate intent deduced by the response analysis unit 308 corresponding to the user-input.

In an example, referring to FIG. 4(a), the interviewee is asked a question as are you willing to relocate? The question becomes the system-input and current state 401 in the state machine model 400. The question may be necessary for shortlisting of desired candidate for a certain job position and fulfilling work-related responsibilities. The current state 401 also indicates an action as ‘waiting for response from the interviewee’.

The user-input 402 from the interviewee can be received as yes, perfectly fine with me in form of audio response and with a facial expression as cheerful and body language & tone as confident in form of video response. Upon receiving the user-input 402, the intent analysis unit 307 determines intent 403 as confident and complete from analysis of the audio and video input. As described earlier, the response analysis unit 308 determines the response i.e. the next state and next action based on the intent and script.

Thus, in one scenario there may not be further questions in the script since the interviewee can be shortlisted as the desired candidate, and therefore the next state 404 can be termination of the conversation session with a termination message as thank you. Accordingly, the next action can be determined as ‘providing the termination message, waiting for response from the interviewee for 10 seconds after providing the termination message and terminating the conversation session’. In another scenario, there can be further questions in the script to finalize the interviewee as the desired candidate, and therefore the next state 405 can be next question from the script. Accordingly, the next action can be determined as ‘providing next question from the script’. As described above, the response analysis unit 308 fetches the script from the content database 206, selects next question based on the intent, and provides the next question to the interviewee. On the contrary, referring to FIG. 4(b), for the same question i.e. the current state 401, user-input 406 from the interview can be received as it depends upon the place in form of audio response and with a facial expression as cheerful but body language & tone as less confident and confused in form of video response. In other words, the interviewee may be interested in relocating to certain places and not to other places. Upon receiving the user-input 406, the intent analysis unit 307 determines intent 407 as confused but complete from analysis of the audio and video input. As described earlier, the response analysis unit 308 determines the response i.e. the next state and next action based on the intent and script. Thus, next state 408 can be a script question as what place are you comfortable with?, such that interviewee's interest can be understood or detected, and next action can be ‘providing the script question to the interviewee’. As described above, the response analysis unit 308 fetches the script from the content database 206, selects next question based on the intent, and provides the next question to the interviewee.

To this question, the interviewee can provide two possible responses. In one situation, the user-input 409 from the interview can be received as only metropolitan cities in form of audio response and with a facial expression as cheerful and body language & tone as confident in form of video response. As such, the intent analysis unit 307 determines intent 410 as confident and complete from analysis of the audio and video input. As described earlier, the response analysis unit 308 determines the response i.e. the next state and next action based on the intent and script. Thus, in one scenario there may not be further questions in the script since the interviewee can be shortlisted as the desired candidate depending upon availability in metro cities, and therefore the next state 411 can be termination of the conversation session with a termination message as thank you. Accordingly, the next action can be determined as ‘providing the termination message, waiting for response from the interviewee for 10 seconds after providing the termination message and terminating the conversation session’. In another scenario, there can be further questions in the script to finalize the interviewee as the desired candidate, and therefore the next state 412 can be next question from the script and next action can be ‘providing the script question to the interviewee’. As described above, the response analysis unit 308 fetches the script from the content database 206, selects next question based on the intent, and provides the next question to the interviewee.

In another situation, the user-input 413 from the interview can be received as where opportunities are more in form of audio response and with a facial expression as straight but body language & tone as confused in form of video response. As such, the intent analysis unit 307 determines intent 414 as less confident and incomplete from analysis of the audio and video input. As described earlier, the response analysis unit 308 determines the response i.e. the next state based on the intent alone. Accordingly, the next state 415 can be follow up question requesting the interviewee to provide specific locations according to his preferences and next action can be ‘providing the script question to the interviewee’. As described above, the response analysis unit 308 fetches the script from the content database 206, selects next question based on the intent, and provides the next question to the interviewee.

On the contrary, referring to FIG. 4(c), for the same question i.e. the current state 401, user-input 416 from the interview can be received as ah . . . hhmm yes . . . (with pauses) in form of audio response and with a facial expression as unhappy and body language & tone as nervous and confused in form of video response. In other words, the interviewee may not be interested in relocating and fears non-selections if contrary answer is given. Upon receiving the user-input 416, the intent analysis unit 307 determines intent 417 as nervous yet complete from analysis of the audio and video input. As described earlier, the response analysis unit 308 determines the response i.e. the next state based on the intent and script. Thus, the next state 418 can be a script question asking are you ok with relocating to metro cities?, such that interviewee's interest or reasons for not relocating can be understood or detected and next action can be ‘providing the script question to the interviewee’. As described above, the response analysis unit 308 fetches the script from the content database 206, selects next question based on the intent, and provides the next question to the interviewee.

To this question, the interviewee can provide two possible responses. In one situation, the user-input 419 from the interview can be received as ye . . . ss . . . (with pauses) in form of audio response and with a facial expression as straight body language & tone as confident in form of video response. In other words, the interviewee may be anxious in relocating but willing to try and relocate to only metro cities. As such, the intent analysis unit 307 determines intent 420 as nervous but willing yet complete from analysis of the audio and video input. As described earlier, the response analysis unit 308 determines the response i.e. the next state based on the intent and script. Thus, in one scenario there are no further questions in the script since the interviewee cannot be shortlisted as the desired candidate, and therefore the next state 421 can be termination of the conversation session with a termination message as thank you. Accordingly, the next action can be determined as ‘providing the termination message, waiting for response from the interviewee for 10 seconds after providing the termination message and terminating the conversation session’.

In another situation, the user-input 422 from the interview can be received as ye . . . sss . . . , . . . I will try . . . (with pauses) in form of audio response and with a facial expression as unhappy and body language & tone as nervous in form of video response. In other words, the interviewee may not be interested at all in relocating. As such, the intent analysis unit 307 determines intent 423 as nervous and unhappy still incomplete from analysis of the audio and video input. As described earlier, the response analysis unit 308 determines the response i.e. the next state based on the intent alone. Accordingly, in one scenario, the next state 424 can be follow up question requesting the interviewee to elaborate further on how he will try since the interviewee can be shortlisted as the desired candidate based on experience and response to previous questions and next action can be ‘providing the script question to the interviewee’. As described above, the response analysis unit 308 fetches the script from the content database 206, selects next question based on the intent, and provides the next question to the interviewee. In another scenario, the next state 425 can be termination of the conversation session with a termination message as thank you since the interviewee cannot be shortlisted as the desired candidate. Accordingly, the next action can be determined as ‘providing the termination message, waiting for response from the interviewee for 10 seconds after providing the termination message and terminating the conversation session’.

Although, the above example illustrates few different possible answers or user-input to question are you willing to relocate?, it is to be understood that there can many different possible answers or user-input to the same question. The intelligent conversation system 201 analyzes the answers or user-input and deduces intent behind the answers or user-input. Based on the intent, the system 201 accordingly determines a next flow of action and provides a corresponding response to the user. As such, the intelligent conversation system 201 provides a personalized response, thereby improving user-experience. Further, the intelligent conversation system 201 provides option to discontinue or continue a conversation session from a particular point in the conversation session based on the intent and the state machine models, as illustrated above. Therefore, the intelligent conversation system 201 is better able to emulate human conversation. In addition, no additional learning is needed by the user 207.

Referring to FIGS. 2 and 3 again, the system 201 includes a timer 309. The timer 309 starts a counter for a predetermined time for each state transition with respect to the state machine model. The timer 309 triggers timeout upon detecting no user-input is received upon expiry of the predetermined time. Conversely, the timer 309 stops the counter upon receiving the user-input prior to expiry of the predetermined time. As the transition occurs based on the deduced intent of the user-input, the next state is dynamic. Therefore, the response analysis unit 308 automatically creates a state transition table based on the user-input and the deduced intent. This enables predictive building of the state machine model and automatic checking and verification of completeness. As such, the conversation session is able to closely emulate human conversation in contrast to a rule-based simulation.

Further, the user-device 203 includes a controller 310 that implements a basic state machine model having finite states such as process, communicate, and wait. The controller 310 determines a current state in the basic state machine model based on user-input, system input, and current state determined by the response analysis unit 308, and performs respective operations associated with the current state. The operations can include, but not limited to, receiving user-input, providing system-input on the output unit 303, communicating user-input to the system 201, waiting for user-input, waiting for next state from the system 201, waiting for the system 201 to process interruption, handling exceptions related to the network 204, and handling timeouts during wait. The controller 310 further transits to a next state based on the system-input or user-input. For example, a start state or node can be waiting for initial user-input and consequently the current state. Upon receiving the user-input, the controller 310 transits to next state as communicate, in which the user-input is communicated or transmitted to the system 201. The controller 310 then transits to next state as wait for communication or response from the system 201.

Further, it would be understood that in client-server architecture a client device operates in response to requests or commands issued by a server. Upon performing a requested operation, the client device transmits an acknowledgement to the server. If the acknowledgement is not received by the server, the server provides the request to the client device again. Therefore, the user-device 203 further transits to the next state in accordance with the current state or response as determined by the state machine model implemented by the response analysis unit 308.

In one example, a system-input is displayed on the output unit 303. The response analysis unit 308 determines the current state as system-input. Accordingly, the controller 310 determines the current state as wait and performs operation of waiting for user-input. Upon receiving the user-input via the input units 304, the controller 310 transits to next state as communicate, in which the user-input is communicated or transmitted to the system 201. Upon communicating the user-input, the controller 310 transits to next state as wait and perform operation of waiting for next request or response from the system 201. The controller 310 remains in this current state until a request is received or timeout is determined.

Upon receiving the user-input, the response analysis unit 308 determines a response based on the user-input. The response is displayed on the output unit 303. The response analysis unit 308 determines the current state as the response. Accordingly, the controller 310 determines the current state as wait and performs operation of waiting for user-input based on the response.

Thus, the conversation session continues until the termination node or state is reached in the state machine model. Thus, the response analysis unit 308 has dual function, i.e., to provide a first question from the script as the system-input on the user-device 203 and to subsequently provide responses based on user-input and intent deduced from the user-input. Upon reaching the termination state, the conversation session is terminated by the response analysis unit 308. Upon termination of the conversation session, a recording unit 311 stores the conversation session in the content database 206. Thus, the recording unit 311 continually records the conversation session that includes all the system-input and user-input, deduced intent, and response, and accordingly stores the conversation session. Such recording and storing of the conversation sessions enable review of various aspects related to each of the conversation sessions such as script, end results, and user-inputs. The review can be performed automatically by the system 201 or by the user 202 who created the script initially such as interviewer and administrator.

Accordingly, the system 201 further includes a feedback generation unit 312 to review the stored conversation session and generate a feedback report upon termination of the conversation session. The feedback report is generated based on intent deduced from user-input received during the conversation session. The feedback report can include the user-input and deduced intent. The feedback report is associated with the conversation session, plurality of context factors, and the profile of the user. Further, the recording unit 311 provides a search facility to enable a user to search for any recorded conversation session and the associated feedback report. In the above example, the interviewer can search for a conversation session regarding a specific interview and the associated feedback report to do a further analysis and determine next course of action such as second round of technical interview or HR interview.

The system 201 further includes a pattern generation unit 313 to review the stored conversation session and identify a repeated pattern across similar conversation sessions. Accordingly, the pattern generation unit 313 selects a set of conversation session from amongst a plurality of pre-stored conversation sessions in the content database 206 based on the plurality of context factors and profile of the user. Thereafter, the pattern generation unit 313 identifies a repetitive pattern in the set of conversation sessions based at least in part on deduced intent of user-input in the set of conversation sessions and learned behavior of users in the set of conversation sessions.

Based on the analysis of the repetitive pattern, the pattern generation unit 313 determines pattern model, generic context factors, and a generic profile of user. In the above example, the pattern generation unit 313 can determine repetitive pattern as ‘interview of certain experience asks for elaboration after each question for a certain position’. Accordingly, the pattern generation unit 308 determines pattern model as ‘providing elaboration after each question’, generic context factor as ‘certain position’, and generic user-profile as ‘certain experience’. In addition, the pattern generation unit 313 can send a report to the user to perform further analysis. In the above example, the pattern generation unit 308 can send a report indicating the pattern model as ‘providing elaboration after each question’ to the interviewer. Based on the pattern model, the interviewer can update the script to include explanation with each question. Further, the pattern generation unit 313 stores the pattern model, generic context factors, and a generic profile of user in the content database 206.

Further, such pattern model can be applied to a new conversation sessions (which may happen in future) having similar generic profile to give users a better personalized and immersive experience. Accordingly, the pattern generation unit 313 determines an initiation of new conversation session for a second user. The new conversation session being pre-associated with a plurality of context factors as said in the art and a profile of the second user. In the above example, a second interviewee can access URL and initiate the conversation session on user-device. As such, the response analysis unit 308 provides a first question from the script as the system-input on the user-device. Simultaneously, the pattern generation unit 313 determines the initiation of the conversation session.

Upon determining, the pattern generation unit 313 fetches the pattern model, generic context factors, and a generic profile of user in the content database 206. The pattern generation unit 313 then determines if the plurality of context factors and the profile of the second user match with the generic context factors and the generic profile. If the profile matches, the pattern model is applied to the new conversation session based on the determination. In the above example, the pattern generation unit 313 determines the second interviewee has the same ‘certain experience’ and has applied for the same ‘certain position’. Accordingly, the pattern generation unit 313 applies the pattern model as ‘providing elaboration after each question’ to the conversation session. In other words, the pattern generation unit 313 directs the response analysis unit 308 to provide explanation along with each question. As described above, the response analysis unit 308 fetches the script from the content database 206, selects explanation as provided in the script based on the pattern model, and provides the explanation to the interviewee.

Further, the response analysis unit 308 learns, trains, and evolves the state machine models associated with various conversation sessions over a period based on the pattern models. Similarly, the pattern generation unit 313 learns, trains, and evolves the pattern models associated with various conversation sessions over a period. Once trained and evolved, the models can generate output, i.e., responses and patterns that are accurate and are able to emulate human conversation.

Thus, the present invention provides an intelligent conversation system that emulates human conversation by deducing intent and following a state machine model, thereby improving user experience. In addition, the present invention enables complete evaluation of every aspect of human behavior during the conversation and details analysis of the conversation session itself based on several parameters, as described above, thereby providing a comprehensive evaluation.

Further, by implementing the intelligent conversation system 201 on the cloud based network 204 and with multi-tenant architecture in client-server environment, scalability of the system 201 is increased considerably while keeping the costs considerably low. In addition, processing time is increase and complexity is reduced as dependency on separate resources is reduced.

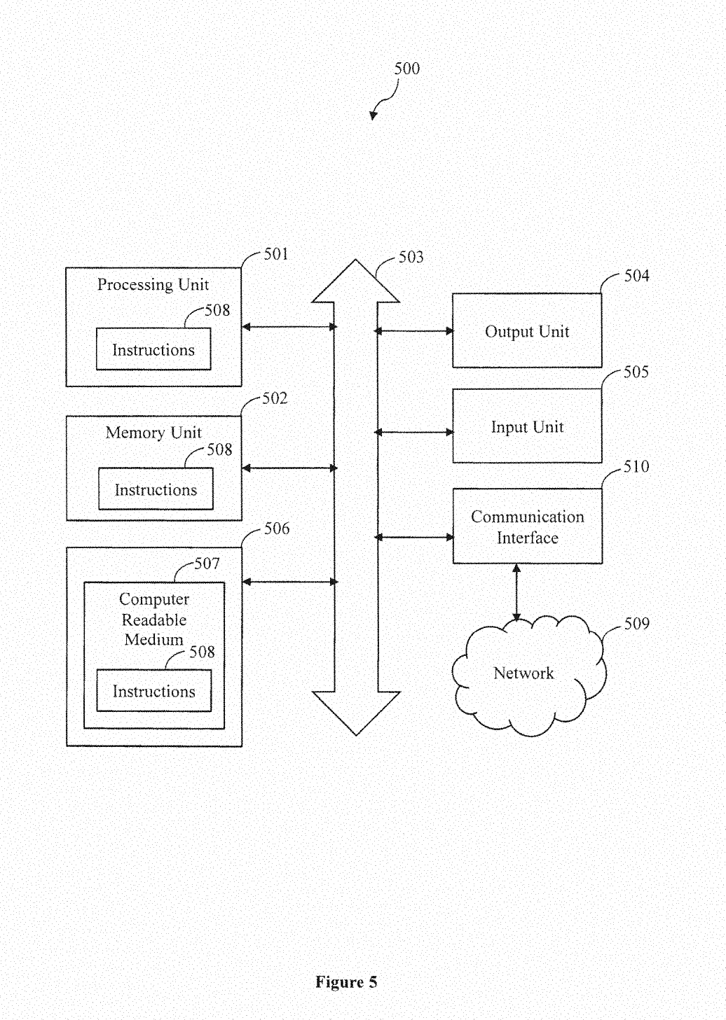

FIG. 5 illustrates a typical hardware configuration of a computing device 500, which is representative of a hardware environment for implementing the invention. The computing device 500 can be any of the system 201 or the user-device 203 as described above, that includes the hardware configuration as described below. The computing device 500 can include a set of instructions that can be executed to cause the computing device 500 to perform any one or more of the methods, in accordance with the invention. The computing device 500 may operate as a standalone device or may be connected, for example, using a network to other computing systems or peripheral devices.

In a networked deployment, the computing device 500 may operate in the capacity of a server or as a client user computer in a server-client user network environment, or as a peer computing system in a peer-to-peer (or distributed) network environment. The computing device 500 can also be implemented as or incorporated into a variety of devices, which are capable of executing a set of instructions (sequential or otherwise) that specify actions to be taken by that device. Furthermore, while a single computing device 500 is illustrated in the figure, the term “system” shall also be taken to include any collection of systems or sub-systems that individually or jointly execute a set, or multiple sets, of instructions to perform one or more computer functions.

The computing device 500 may include a processing unit 501 e.g., a central processing unit (CPU), a graphics processing unit (GPU), or both. The processing unit 501 may be a component in a variety of systems. For example, the processing unit 501 may be part of a standard personal computer or a workstation. The processing unit 501 may be one or more general processors, digital signal processors, application specific integrated circuits, field programmable gate arrays, servers, networks, digital circuits, analog circuits, combinations thereof, or other now known or later developed devices for analysing and processing data. The processing unit 501 may implement a software program, such as code generated manually (i.e., programmed).

The computing device 500 may include a memory unit 502, such as a memory unit 502 that can communicate via a bus 503. The memory unit 502 may be a main memory, a static memory, or a dynamic memory. The memory unit 502 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory unit 502 includes a cache or random access memory for the processing unit 501. In alternative examples, the memory unit 502 is separate from the processing unit 501, such as a cache memory of a processor, the system memory, or other memory. The memory unit 502 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory unit 502 is operable to store instructions executable by the processing unit 501. The functions, acts or tasks illustrated in the figures or described may be performed by the programmed processing unit 501 executing the instructions stored in the memory unit 502. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computing device 500 may or may not further include an output unit 504, such as an audio unit and/or a display unit. The examples of the display unit include, but are not limited to a liquid crystal display (LCD), an organic light emitting diode (OLED), a flat panel display, a solid state display, a cathode ray tube (CRT), a projector, a printer or other now known or later developed display device for outputting determined information. The output unit 504 may act as an interface for the user to listen/see the functioning of the processing unit 501, or specifically as an interface with the software stored in the memory unit 502 or in a removable storage device. Additionally, the computing device 500 may include an input unit 505 configured to allow a user to interact with any of the components of system (300). The input unit 505 may be a number pad, a keyboard, or a cursor control device, such as a mouse, or a joystick, remote control or any other device operative to interact with the computing device 500. Sometimes, a single IO unit, such a touch screen display, can serve the function of the output unit 504 as well as the input unit 505.

The computing device 500 may also include a disk or optical drive unit 506. The disk drive unit 506 may include a computer-readable medium 507 in which one or more sets of instructions 508, e.g. software, can be embedded. Further, the instructions 508 may embody one or more of the methods or logic as described. In a particular example, the instructions 508 may reside completely, or at least partially, within the memory unit 502 or within the processing unit 501 during execution by the computing device 500. The memory unit 502 and the processing unit 501 also may include computer-readable media as discussed above.

The present invention contemplates a computer-readable medium that includes instructions 508 or receives and executes instructions 508 responsive to a propagated signal so that a device connected to a network 509 can communicate voice, video, audio, images or any other data over the network 509. Further, the instructions 508 may be transmitted or received over the network 509 via a communication port or interface 510 or using the bus 503. The communication port or interface 510 may be a part of the processing unit 501 or may be a separate component. The communication port or interface 510 may be created in software or may be a physical connection in hardware. The communication port or interface 510 may be configured to connect with the network 509, external media, the output unit 504, or any other components in the computing device 500 or combinations thereof. The connection with the network 509 may be a physical connection, such as a wired Ethernet connection or may be established wirelessly as discussed later. Likewise, the additional connections with other components of the computing device 500 may be physical connections or may be established wirelessly. The network 509 may alternatively be directly connected to the bus 503.

The network 509 may include wired networks, wireless networks, Ethernet AVB networks, or combinations thereof. The wireless network may be a cellular telephone network, an 802.11, 802.16, 802.20, 802.1Q or WiMAX network. Further, the network 509 may be a public network, such as the Internet, a private network, such as an intranet, or combinations thereof, and may utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the computing device 500.

The present invention can be implemented on a variety of electronic and computing systems. For instance, one or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

Any one or more of the methods or logic as described may be implemented in part by software programs executable by a computing system. Further, in a non-limited example, implementations can include distributed processing, component/object distributed processing, and parallel processing. Alternatively, virtual computing system processing can be constructed to implement various parts of the computing device 500.

The computing device 500 is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. In addition, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

While certain present preferred embodiments of the invention have been illustrated and described herein, it is to be understood that the invention is not limited thereto. Clearly, the invention may be otherwise variously embodied, and practiced within the scope of the following claims.

We claim:

1. A method comprising:
receiving a user-input from a user in a conversation session from one or more input units coupled to a user-device, the user-input being a combination of audio, video, and text, and the conversation session being initiated by the user;
deducing an intent of the user-input;
determining a response based at least in part on the deduced intent; and
providing the response on the output unit within the conversation session.

2. The method as claimed in claim 1, further comprises:
providing a system-input to the user via at least one output unit of the user-device prior to receiving the user-input in the conversation session, the system-input being one of: information, question, and query.

3. The method as claimed in claim 2, wherein the system-input is selected from a script pre-associated with the conversation session, the script including a list of questions and mapped answers and actions.

4. The method as claimed in claim 2, wherein deducing the intent of the user-input comprises:
analysing the user-input and the system-input to identify one or more parameters indicative of the intent;
assigning a predetermined weightage to each of the one or more identified parameters; and
deducing the intent based on an aggregation of the predetermined weightage of each of the one or more identified parameters.

5. The method as claimed in claim 4, wherein the one or more parameters include similarity of concept between the user-input and the system-input, sentiment of the user, emotion of the user, gesture of the user, tone of the user, body language of the user, expression of the user, code of conduct of the user, environmental factors, and a duration from said providing until receiving of the user-input from the user.

6. The method as claimed in claim 1, wherein the determination of the response is further based on the user-input, intent deduced from user-input corresponding to prior system-input within the conversation session, intent deduced from user-input corresponding system-input within a plurality of pre-stored conversation sessions, and the script.

7. The method as claimed in claim 6, wherein the determination of the response comprises:
determining a current state in a state machine model based on the system-input, the state-machine model being pre-associated with the conversation session; and
traversing the state-machine model based on the user-input, the deduced intent, and one or more pre-stored rules to determine next state.

8. The method as claimed in claim 7, wherein the next state comprises one of:
a secondary question from the pre-stored script, the secondary question being one of a follow-on question and different question;
a repetition of the system-input;
a resolution related to a user-query;
a follow-up message;
a termination message; and
a repetition of the conversation session.

9. The method as claimed in claim 1, wherein the conversation session is pre-associated with a plurality of context factors and a profile of the user.

10. The method as claimed in claim 9, further comprises, upon termination of the conversation session:
selecting a set of conversation sessions from amongst a plurality of pre-stored conversation sessions based on the plurality of context factors and the profile of the user;
identifying a repetitive pattern in the set of conversation sessions based at least in part on deduced intent of user-input in the set of conversation sessions and learned behaviour of users in the set of conversation sessions; and
determining a pattern model, generic context factors, and a generic profile of user based on an analysis of repetitive pattern.

11. The method as claimed in claim 10, further comprising
detecting an initiation of a new conversation session for a second user, the new conversation session being pre-associated with a plurality of context factors and a profile of the second user;
determining if the plurality of context factors and the profile of the second user matches with the generic context factors and the generic profile; and
applying the pattern model to the new conversation session based on the determination.

12. The method as claimed in claim 1, further comprises:
recording and storing the conversation session; and
enabling a search for the stored conversation by user.

13. The method as claimed in claim 1, further comprises:
generating a feedback report upon termination of the conversation session, said report based on intent deduced from user-input received during the conversation session.

14. A system comprising:
a receiving unit to receive a user-input from a user in a conversation session from one or more input units coupled to a user-device, the input being a combination of audio, video, and text, and the conversation session being initiated by the user;
an intent analysis unit to deduce an intent of the user-input;
a response analysis unit to determine a response based at least in part on the user-input and the deduced intent; and
the transmitting unit to provide the response within the conversation session to the at least one output unit.

15. The system as claimed in claim 14, further comprises a transmitting unit to provide a system-input to the user, prior to receiving the user-input, via at least one output unit of the user-device in the conversation session, the system-input being one of: information, question, and query.

16. The system as claimed in claim 14, wherein the intent analysis unit to deduce the intent further:
analyses the user-input and the system-input to identify one or more parameters indicative of the intent;
assigns a predetermined weightage to each of the one or more identified parameters; and
deduces the intent based on an aggregation of the predetermined weightage of each of the one or more identified parameters.

17. The system as claimed in claim 15, wherein the one or more parameters include similarity of concept between the user-input and the system-input, sentiment of the user, emotion of the user, gesture of the user, tone of the user, body language of the user, expression of the user, code of conduct of the user, environmental factors, and a duration from said providing until receiving of the user-input from the user.

18. The system as claimed in claim 14, wherein the determination of the response is further based on the user-input, intent deduced from user-input corresponding prior system-input within the conversation session, intent deduced from user-input corresponding system-input within a plurality of pre-stored conversation sessions, and a script pre-associated with the conversation session.

19. The system as claimed in claim 17, wherein the response analysis unit to determine the response:
determines a current state in a state machine model based on the system-input, the state-machine model being pre-associated with the conversation session; and
traverses the state-machine model based on the user-input, the deduced intent, and one or more pre-stored rules to determine next state.

20. The system as claimed in claim 14, wherein the conversation session is pre-associated with a plurality of context factors and a profile of the user.

21. The system as claimed in claim 19, further comprises a pattern generation unit, wherein the pattern generation unit upon termination of the conversation session:
selects a set of conversation sessions from amongst a plurality of pre-stored conversation sessions in a storing unit based on the plurality of context factors and the profile of the user;
identifies a repetitive pattern in the set of conversation sessions based at least in part on deduced intent of user-input in the set of conversation sessions and learned behaviour of users in the set of conversation sessions; and
determines a pattern model, generic context factors, a generic profile of user based on an analysis of repetitive pattern.

22. The method as claimed in claim 20, wherein the pattern generation unit further
detects an initiation of a new conversation session for a second user, the new conversation session being pre-associated with a plurality of context factors and a profile of the second user;
determines if the plurality of context factors and the profile of the second user matches with the generic context factors and the generic profile; and
applies the pattern model to the new conversation session based on the determination.

23. The system as claimed in claim 14, further comprises:
a recording unit to record and store the conversation session in a storage unit; and
a searching unit to enable a search of the stored conversation session in the storage unit.

24. The system as claimed in claim 14, further comprises:
a feedback generating unit to generate a feedback report upon termination of the conversation session, said report based on intent deduced from user-input received during the conversation session.

25. The system as claimed in claim 14, wherein the at least one output unit comprises: display unit and audio output unit.

26. The system as claimed in claim 14, wherein the one or more input units include high-definition video camera, microphone, touch-based display unit, non-touch based display unit, sensor, wearable device, keyboard, stylus, and mouse.
